(19) United States
(12) Patent Application Publication
(10) Pub. No.: US 2022/0308991 A1
(43) Pub. Date: Sep. 29, 2022

(54) TEST PROCESSING METHOD AND INFORMATION PROCESSING APPARATUS

(71) Applicant: FUJITSU LIMITED, Kawasaki-shi (JP)

(72) Inventors: Yukihiro KIMURA, Kawasaki (JP); Haruhito NAGATA, Numazu (JP); Masanori Yano, Numazu (JP); Kazuhisa Takakuri, Kawasaki (JP); Takuya KIRIYAMA, Numazu (JP); Terumi KASAI, Mishima (JP); Kenji Kazumura, Mishima (JP)

(73) Assignee: FUJITSU LIMITED, Kawasaki-shi (JP)

(21) Appl. No.: 17/699,435

(22) Filed: Mar. 21, 2022

(30) Foreign Application Priority Data
Mar. 26, 2021 (JP) 2021-053156

(51) Int. Cl. G06F 11/36

(52) U.S. Cl. CPC G06F 11/3692; G06F 11/3688; G06F 11/3684

(57) ABSTRACT

An information processing apparatus includes a memory and a processor. The memory holds software and a test program configured separately from the software. The processor invokes the test program, based on a test specification information that indicates execution of the software in a test mode. By using the invoked test program, the processor determines an address that indicates a variable for use by a function included in the software and rewrites a value of the variable indicated by the address.

### CROSS-REFERENCE TO RELATED APPLICATION

This application is based upon and claims the benefit of priority of the prior Japanese Patent Application No. 2021-053156, filed on Mar. 26, 2021, the entire contents of which are incorporated herein by reference.

### FIELD

The embodiments discussed herein relate to a test processing method and an information processing apparatus.

### BACKGROUND

In software development, a software test is performed to check that created software operates properly according to its specifications. There are cases where a software test includes a procedure of setting the internal state of software to a certain state and checking the behavior of the software in this internal state. For example, there are cases where a software test includes a procedure of setting the internal state of the software to an abnormal state and checking that recovery processing from the abnormal state is properly performed.

There has been proposed a module verification system that achieves reduction of the man-hours for a test by loading a plurality of modules included in a test target program to a debugger, dynamically connecting a stub program in this state in which the modules are loaded to the debugger, and performing a single test on an individual module.

See, for example, Japanese Laid-open Patent Publication No. 2008-135008.

Depending on the software, it may be difficult to intentionally create a certain internal state through a normal external operation alone. For example, there are cases where it is difficult to recreate a certain abnormal state only by changing input data to be entered to the software. In this case, there are cases where a software test includes a procedure of embedding a test program into the software and causing the internal test program to forcibly create a certain internal state.

### SUMMARY

According to an aspect, there is provided a non-transitory computer-readable recording medium storing therein a computer program that causes a computer to execute a process including: invoking, based on a test specification information that indicates execution of software in a test mode, a test program configured separately from the software; determining an address that indicates a variable for use by a function included in the software, by using the test program being invoked; and rewriting a value of the variable indicated by the address.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus according to a first embodiment;

FIG. 2 is a block diagram illustrating a hardware example of an information processing apparatus;

FIG. 3 illustrates a structure example of a software product;

FIG. 4 illustrates a first example of a product module and a test module;

FIG. 5 illustrates a second example of a product module and a test module;

FIG. 6 illustrates a calculation example of the address of a local variable;

FIG. 7 illustrates a third example of a product module and a test module;

FIG. 8 illustrates a fourth example of a product module and a test module;

FIG. 9 illustrates a structure example of a product module and a test module;

FIG. 10 is a block diagram illustrating a functional example of the information processing apparatus;

FIG. 11 is a flowchart illustrating a procedure example of a compilation thread; and

FIG. 12 is a flowchart illustrating a procedure example of address resolution.

### DESCRIPTION OF EMBODIMENTS

Hereinafter, embodiments will be described with reference to the accompanying drawings.

### First Embodiment

A first embodiment will be described.

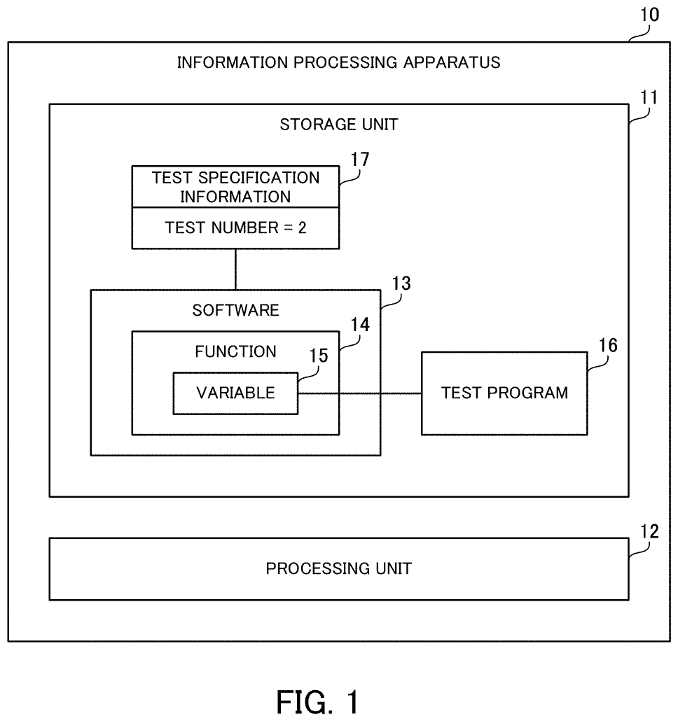

FIG. 1 illustrates an information processing apparatus according to a first embodiment.

This information processing apparatus 10 according to the first embodiment supports software tests. The information processing apparatus 10 may be a client apparatus or a server apparatus. The information processing apparatus 10 may be called a computer, a test processing apparatus, or a software development apparatus.

The information processing apparatus 10 includes a storage unit 11 and a processing unit 12. The storage unit 11 may be a volatile semiconductor memory, such as a random access memory (RAM), or a non-volatile storage, such as a hard disk drive (HDD) or a flash memory. For example, the processing unit 12 is a processor, such as a central processing unit (CPU), a graphics processing unit (GPU), or a digital signal processor (DSP). The processing unit 12 may include an electronic circuit for specific use, such as an application specific integrated circuit (ASIC) or a field programmable gate array (FPGA). The processor executes a program stored in a memory, such as a RAM. A group of processors may be referred to as a multi-processor or simply a processor.

The storage unit 11 holds software 13 and a test program 16. The software 13 is a software product to be tested or a product module, which is a part of the software product. The software 13 includes at least one program file. The software 13 may be middleware, such as a program execution environment used for execution of a user program. The program execution environment may include a Just In Time (JIT) compiler that converts a high-level language program or an intermediate language program into a machine language program.

The software 13 includes a function 14. The function 14 is a program unit that performs certain information processing when the program unit is invoked. The function 14 may be called a method, a procedure, or a subroutine. The function 14 uses a variable 15 in the information processing. The value of the variable 15 may represent an internal state of the software 13.

The variable 15 may be a local variable of the function 14. The function 14 and a different function invoked by the function 14 are able to refer to the local variable of the function 14. No other elements outside the function 14 are able to refer to the local variable of the function 14. The value of the local variable may be stored in a stack area in a memory. A relative position, where the value of the local variable is stored, in the stack area is determined, for example, by a compiler that compiles the function 14. When a plurality of functions are invoked in a hierarchical manner, the values of the local variables of the individual functions are accumulated in the stack area.

The test program 16 is a test module configured separately from the software 13. The test program 16 defines processing for setting the internal state of the software 13 to a certain state when the test program 16 is invoked. The certain state may be a state that is difficult to recreate by a normal input operation entered to the software 13 from the outside. The certain state may be an abnormal state indicating memory access violation, internal contradiction detection, no response, or the like. The test program 16 may define processing for creating a different internal state depending on the test number specified.

In addition, the test program 16 may hold information for determining an address that indicates the variable 15. For example, the address that indicates the variable 15 is a memory address that indicates the location, where the value of the variable 15 is stored, on a memory. The information held by the test program 16 may be an offset that indicates an address difference from a reference location in the stack area. The information may also be table information in which a variable name and an offset are associated with each other.

As described above, the location of the variable 15 may be determined by the compiler that compiles the function 14. Thus, the information held by the test program 16 may be generated prior to the start of a test by analyzing an instruction of the function 14 compiled. Alternatively, the information may be generated prior to the start of a test by extracting memory allocation information from the compiler.

The processing unit 12 tests the software 13 by using the test program 16. The processing unit 12 receives test specification information 17 that indicates execution of the software 13 in a test mode. The test specification information 17 may be inputted by a developer. The test specification information 17 may be an option included in a command for starting the software 13. The test specification information 17 may include a test number that indicates a test type.

The processing unit 12 invokes the test program 16 in accordance with the test specification information 17. The processing for invoking the test program 16 upon receiving the test specification information 17 may be defined in the software 13 or in the function 14.

When invoking the test program 16, the processing unit 12 may extract a digital signature from the test program 16. If the verification of the digital signature fails, the processing unit 12 may deny invoking of the test program 16. In the verification of a digital signature, for example, the processing unit 12 decrypts the digital signature with a certain encryption key, calculates a hash value of a different portion of the test program 16, and determines whether the decryption result and the hash value match. If the decryption result and the hash value match, the processing unit 12 determines that the verification has succeeded. If not, the processing unit 12 determines that the verification has failed. In this way, the processing unit 12 denies invoking of an unauthorized program that has not been created by the person who is performing the test.

The processing unit 12 determines an address that indicates the variable 15 by using the invoked test program 16 and rewrites the value of the variable 15 indicated by the determined address. For example, in accordance with an instruction included in the test program 16, the processing unit 12 changes the value of the variable 15 to a certain abnormal value that corresponds to the test number included in the test specification information 17. In this way, the processing unit 12 forcibly sets the internal state of the software 13 to a certain state.

For example, after rewriting the value of the variable 15, the processing unit 12 continues the execution of the function 14. The processing unit 12 saves a log that indicates the processing result of the software 13 in a memory. In this way, a software test for checking the behavior of the software 13 in a certain internal state is achieved. For example, the behavior of the software 13 in an abnormal state that rarely occurs is checked.

As described above, the information processing apparatus 10 according to the first embodiment performs a test on the software 13. Thus, operations that do not match the specifications of the software 13 are detected, and defects of the software 13 are found. As a result, the quality of the software 13 is improved through debugging.

In addition, the information processing apparatus 10 performs a software test by using the test program 16 outside the software 13. Thus, the developer does not need to embed a test program into the software 13 and to temporarily modify the software 13 for a test. Thus, a risk of causing defects in the software 13 through a test operation is reduced, and the burden of managing the quality of the software 13 is reduced. In addition, a security risk of the test program remaining in the software 13 is reduced.

In addition, in the case of the information processing apparatus 10, the test program 16 is invoked to determine the address of the variable 15 and externally rewrite the value of the variable 15. In this way, the information processing apparatus 10 sets the software 13 to a certain internal state from the outside of the software 13. Thus, the information processing apparatus 10 is able to intentionally create an internal state (for example, a certain abnormal state indicating memory access violation or the like) that is difficult to recreate only by a normal input operation entered to the software 13.

Therefore, a software test is facilitated.

### Second Embodiment

Next, a second embodiment will be described.

An information processing apparatus 100 according to the second embodiment supports software tests. The information processing apparatus 100 corresponds to the information processing apparatus 10 according to the first embodiment. The information processing apparatus 100 may be a client apparatus or a server apparatus.

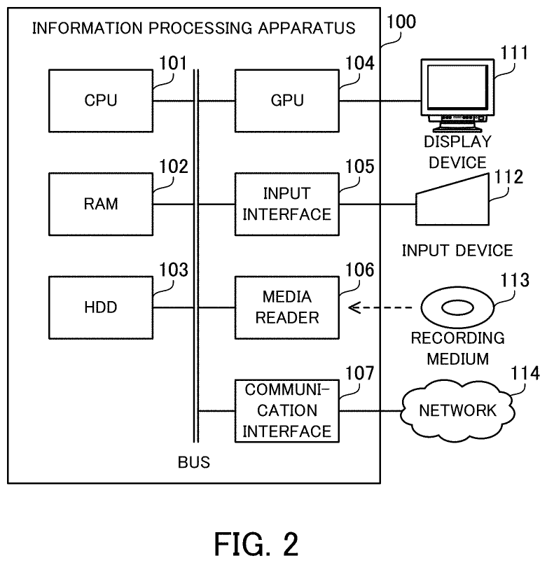

FIG. 2 is a block diagram illustrating a hardware example of the information processing apparatus.

The information processing apparatus 100 includes a CPU 101, a RAM 102, an HDD 103, a GPU 104, an input interface 105, a media reader 106, and a communication interface 107, which are connected to a bus. The CPU 101 corresponds to the processing unit 12 according to the first embodiment. The RAM 102 or the HDD 103 corresponds to the storage unit 11 according to the first embodiment.

The CPU 101 is a processor that executes program instructions. The CPU 101 executes a program by loading at least part of the program and data stored in the HDD 103 to the RAM 102. The information processing apparatus 100 may include a plurality of processors. A group of processors may be referred as a multi-processor or simply “a processor”.

The RAM 102 is a volatile semiconductor memory that temporarily holds a program executed by the CPU 101 and data used for calculation by the CPU 101. The information processing apparatus 100 may include a different kind of volatile memory other than a RAM.

The HDD 103 is a non-volatile storage that holds an operating system (OS), middleware, software programs such as application software, and data. The information processing apparatus 100 may include a different kind of non-volatile storage, such as a flash memory or a solid-state drive (SSD).

The GPU 104 generates an image in coordination with the CPU 101 and outputs the image to a display device 111 connected to the information processing apparatus 100. For example, the display device 111 is a cathode ray Tube (CRT) display, a liquid crystal display, an organic electro luminescence (EL) display, or a projector. A different kind of output device, such as a printer, may be connected to the information processing apparatus 100.

The input interface 105 receives an input signal from an input device 112 connected to the information processing apparatus 100. The input device 112 is, for example, a mouse, a touch panel, or a keyboard. A plurality of input devices may be connected to the information processing apparatus 100.

The media reader 106 is a reading device that reads a program and data recorded in a recording medium 113. The recording medium 113 is, for example, a magnetic disk, an optical disc, or a semiconductor memory. Examples of the magnetic disk include a flexible disk (FD) and an HDD. Examples of the optical disc include a compact disc (CD) and a digital versatile disc (DVD). The media reader 106 copies the program and data read from the recording medium 113 to a different recording medium, such as the RAM 102 and the HDD 103. The read program may be executed by the CPU 101.

The recording medium 113 may be a portable recording medium. The recording medium 113 may be used to distribute a program and data. In addition, the recording medium 113 and the HDD 103 may be referred to as computer-readable recording media.

The communication interface 107 is connected to a network 114 and communicates with a different information processing apparatus via the network 114. The communication interface 107 may be a wired communication interface connected to a wired communication device, such as a switch or a router. Alternatively, the communication interface 107 may be a wireless communication interface connected to a wireless communication device, such as a base station or an access point.

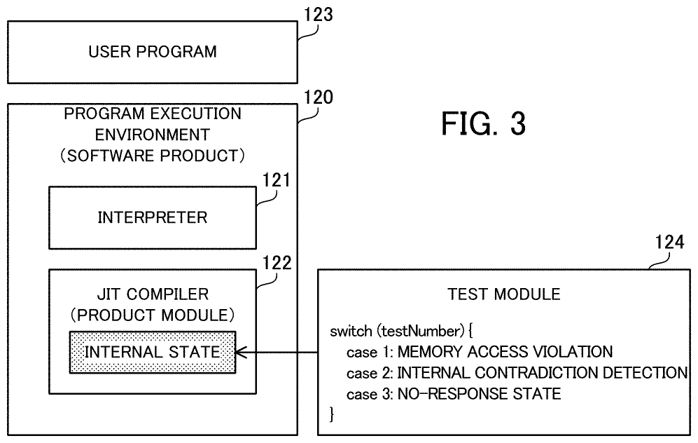

FIG. 3 illustrates a structure example of a software product.

The developer of a software product develops a program execution environment 120 such that a user program operates on the information processing apparatus 100. The program execution environment 120 is a software product provided to a third party with or without charge. The information processing apparatus 100 performs a test on the program execution environment 120 for quality improvement. The program execution environment 120 is middleware that is located between a user program 123 and computer hardware and that controls execution of the user program 123. The program execution environment 120 may be referred to as a virtual machine or a framework.

The user program 123 is written in an intermediate language having an abstraction level between those of a high-level language and a machine language. The user program 123 is generated by compiling a source code written in a high-level language. The user program 123 may be referred to as an intermediate code or a bytecode. The program execution environment 120 converts an intermediate language instruction of the user program 123 into a machine language instruction. The program execution environment 120 enables a machine language instruction set to execute the user program 123 on various different processors.

The program execution environment 120 includes an interpreter 121 and a JIT compiler 122. The program execution environment 120 receives a command that specifies the user program 123. In response, the interpreter 121 interprets intermediate language instructions included in the user program 123 one by one, converts these instructions into corresponding machine language instructions, and causes a processor to perform the machine language instructions. In this operation, the interpreter 121 monitors the invoking frequency of an individual method. The individual method is an invokable program unit. The individual method may be referred to as a function, a procedure, or a subroutine.

The interpreter 121 counts the number of times the individual method has been invoked. If the number of times a method has been invoked reaches a threshold (3, for example), the interpreter 121 requests the JIT compiler 122 to compile the method. This is because faster processing is achieved by converting a group of intermediate language instructions of a frequently invoked method into machine language instructions in advance, rather than interpreting the intermediate language instructions one by one. The processing of the interpreter 121 and the processing of the JIT compiler 122 may be performed by a single processor core in a time-shared manner or by different processor cores in a parallel manner. The processing of the JIT compiler 122 may be referred to as a compilation thread.

The JIT compiler 122 converts a bytecode (a group of intermediate language instructions) of a method specified by the interpreter 121 into a native code (a group of machine language instructions). In this operation, the JIT compiler 122 may optimize the native code so that the execution speed increases. The JIT compiler 122 holds the generated native code. If a compiled method has been invoked, the program execution environment 120 causes a processor to execute the native code, instead of causing the interpreter 121 to interpret the bytecode.

However, there are cases where the JIT compiler 122 fails to compile the bytecode due to occurrence of an abnormal state. There are cases where an abnormal state occurs due to a defect (a so-called bug) on the program of the JIT compiler 122. Examples of the abnormal state include memory access violation where an inappropriate memory area is accessed, internal contradiction detection where some pieces of the data generated during a compilation do not match each other, and a no-response state where the progress of the compilation stops due to an endless loop or waiting for an event. If the JIT compiler 122 fails a compilation, the JIT compiler 122 adds a failure flag to the method and stops the subsequent compilation of the method.

If the JIT compiler 122 fails a compilation, the JIT compiler 122 performs recovery processing for recovering the program execution environment 120 to its normal state. The recovery processing is ex-post processing for preventing the error of the JIT compiler 122 from affecting other functions of the program execution environment 120. For example, in the recovering processing, the data on a memory is recovered to its pre-compilation state.

The JIT compiler 122 is an example of a product module contained in the software product. The information processing apparatus 100 according to the second embodiment performs a test on the program execution environment 120, in particular, a test on the recovery processing of the JIT compiler 122. In a test on the recovery processing based on a compilation thread, the information processing apparatus 100 executes the JIT compiler 122 by intentionally setting the internal state of the JIT compiler 122 to a certain abnormal state.

However, some of the abnormal states to be tested are difficult to recreate only by a normal input operation entered from the outside of the JIT compiler 122. Thus, in one conceivable method, the developer temporarily modifies the source code of the JIT compiler 122 and embeds a test code that forcibly causes an abnormal state into the source code. For example, the test code rewrites the value of a certain variable to an abnormal value.

However, in accordance with this method, the developer needs to remove the test code after the test and to complete the JIT compiler 122 such that the functions other than the test code will be the same as those prior to the test. Therefore, the burden of managing the quality of the JIT compiler 122 is increased. In addition, if the test code remains in the JIT compiler 122, the test code could cause a defect, thereby increasing the security risk. In addition, to change the test case, the developer needs to rebuild the JIT compiler 122 by, for example, re-compiling the source code. Therefore, the work burden of the test itself is increased.

In another conceivable method, the developer may cause a processor to execute instructions of the JIT compiler 122 while rewriting a content of a register or a memory at a certain time by using a development support tool referred to as a debugger. However, since the developer operates the debugger while paying attention to low-level instructions or data structures, the burden of the test work is heavy, and as a result, the man-hours for the test could increase. In addition, the developer's learning cost for learning the test technique is high.

To solve the above problems, the information processing apparatus 100 according to the second embodiment uses a test module 124 prepared outside of the JIT compiler 122, to change the internal state of the JIT compiler 122. The test module 124 is not embedded into the program execution environment 120 and is a dynamic link library invoked by the JIT compiler 122 when a test is performed.

When the program execution environment 120 receives a command including an option that indicates the start of the program execution environment 120 in the test mode, the JIT compiler 122 invokes the test module 124. This option is a non-public option that is not disclosed to a third party to which the program execution environment 120 is provided. The option includes a test number that indicates a test type. The JIT compiler 122 notifies the test module 124 of the test number when invoking the test module 124. Based on the specified test number, the test module 124 rewrites the value of a variable included in the JIT compiler 122 and forcibly creates a certain abnormal state.

However, simply separating the test module 124 from the JIT compiler 122 only allows the test module 124 to have a limited access of reference to the variables and functions of the JIT compiler 122, in view of the scope.

In one conceivable method, the JIT compiler 122 transfers the addresses of the variable and the function used by the test module 124 to the test module 124 as function invoking parameters. However, in this method, the data structures of the parameters changes depending on the test contents, and much modification work on the JIT compiler 122 and the test module 124 could be needed. In another conceivable method, the scope of the variables and functions included in the JIT compiler 122 are set such that an external module is able to refer to the variables and functions. However, in this method, the security risk could increase.

Thus, in the second embodiment, to facilitate a software test, a product module and a test module are created to have the following program structures. A setting file may be prepared outside the test module 124 so that details of the behavior of the test module 124 are specified easily.

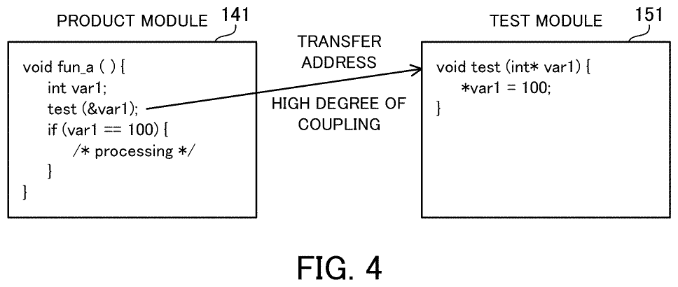

FIG. 4 is a first example of a product module and a test module.

This product module 141 includes a function fun_a. The function fun_a has a variable var1, which is an integer-type local variable. The function fun_a transfers the address of the variable var1 on a memory as a parameter and invokes a function test of a test module 151. Next, the function fun_a performs processing based on the value of the variable var1.

The test module 151 includes the function test that receives a pointer corresponding to the integer-type variable as a parameter. The function test rewrites the value of the variable var1 indicated by the received pointer to a certain value. The product module 141 and the test module 151 have a high degree of coupling since the data structure of the parameter depends on the test content of the test module 151. Thus, the program structures of the product module and the test module are changed as follows.

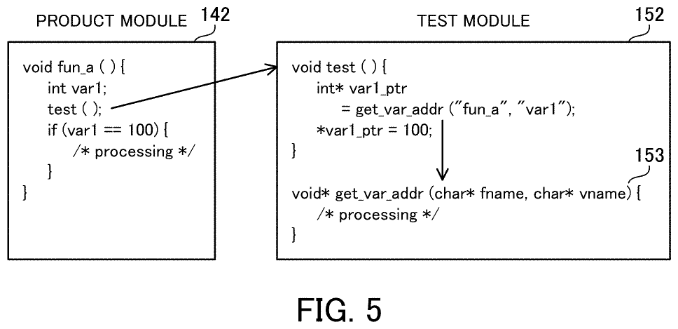

FIG. 5 illustrates a second example of a product module and a test module.

This product module 142 includes a function fun_a. The function fun_a has a variable var1, which is an integer-type local variable. The function fun_a invokes a function test of a test module 152. The function test of the test module 152 does not have a parameter. Next, the function fun_a performs processing based on the value of the variable var1.

The test module 152 includes the function test and a function get_var_addr (function 153). The function 153 is a utility function that receives a function name fname and a variable name vname as parameters and that transfers the address of the variable determined by the parameters as a response. The function 153 may be referred to as an address resolution function. In order to rewrite a value of a target local variable among the variables of the product module 142, the function test invokes the function 153 by specifying the name of the function to which the local variable belongs and the name of the local variable. Then, the function test rewrites the value of the variable indicated by a pointer received from the function 153 to a certain value.

The function 153 calculates the address of the specified local variable by using a stack offset table 175 to be described below. The local variable whose address is resolved by the function 153 is a local variable of a function that is reached by tracing the invoking source function in the order opposite to the invoking direction from the test module 152. The stack offset table 175 is created in advance by the developer who tests the product module 142.

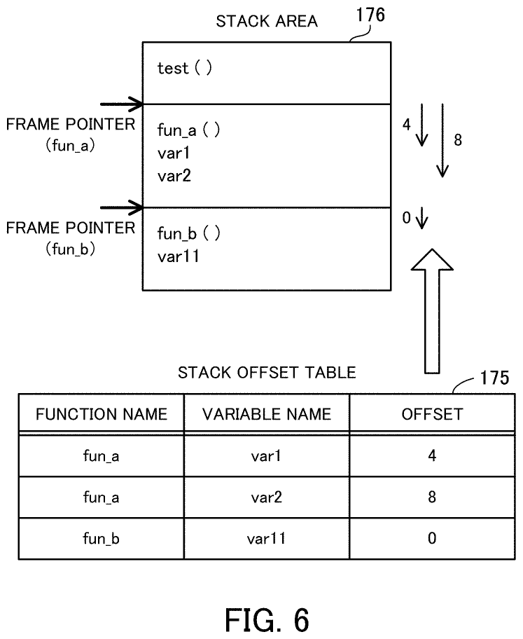

FIG. 6 illustrates a calculation example of the address of a local variable.

A memory includes a stack area 176. When the function test of the test module 152 is invoked, information about at least one function having been executed by the time function test is reached is accumulated in the stack area 176 in a hierarchical manner. Herein, as an example, the invoking source of the function test is the function fun_a, and the invoking source of the function fun_a is the function fun_b.

If the function fun_a has variables var1 and var2, the values of the variables var1 and var2 are stored in a section corresponding to the function fun_a in the stack area 176. Likewise, if the function fun_b has a variable var11, the value of the variable var11 is stored in a section corresponding to the function fun_b in the stack area 176. The top of the section of the function fun_a indicates the frame pointer of the function fun_a. The top of the section of the function fun_b indicates the frame pointer of the function fun_b.

How the value of the local variable is stored in the stack area 176 is statically determined by the compiler that compiles the product module 142. Thus, no matter how many times the product module 142 is executed, the memory address difference (offset) from the frame pointer to the top of the local variable is always the same. For example, the location of the variable var1 of the function fun_a is 4 bytes behind the frame pointer of the function fun_a. The location of the variable var2 of the function fun_a is 8 bytes behind the frame pointer of the function fun_a. The location of the variable var11 of the function fun_b is the location of the frame pointer of the function fun_b.

Thus, a function name, a variable name, and an offset are associated with each other in the stack offset table 175. The stack offset table 175 is associated with the product module 142. A single stack offset table is created for a single product module. The function 153 searches the stack offset table 175 for the offset corresponding to the function name and the variable name received as parameters. The function 153 calculates the address of the variable by adding the offset to the frame pointer corresponding to the function name. The frame pointer corresponding to the function name is detected by tracing the stack area 176 in the opposite direction.

The stack offset table 175 is created by analyzing the product module 142. For example, the information processing apparatus 100 converts a compiled product module 142 into an assembly code. Alternatively, the developer sets up the compiler that compiles the product module 142 so as also to output an assembly code. The information processing apparatus 100 detects, from the assembly code, an instruction for storing the value of the local variable in the stack area 176. The developer determines the offset of the individual local variable based on the detected instruction. The stack offset table 175 may be embedded into the function 153 or may be stored as a setting file outside the function 153.

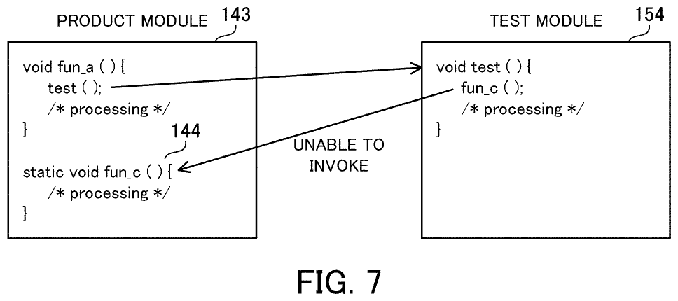

FIG. 7 illustrates a third example of a product module and a test module.

This product module 143 includes a function fun_a and a function fun_c (function 144). The function 144 is a non-global function, and reference thereto by using a function name from an external module is restricted. The function 144 corresponds to a static function in the C++ language, for example. The static function is a non-global function whose scope is limited within the same module while use of the same function name as that of an external module is allowed.

The function fun_a invokes a function test of a test module 154. The test module 154 includes the function test. The function test invokes the function 144 to change the internal state of the product module 143. However, since the function test exists outside the product module 143, the function name of the function 144 is not recognized by the function test. Thus, the function test fails to invoke the function 144 in a normal manner by using the function name. Therefore, for address resolution of the function 144, the program structures of the product module and the test module are changed as follows.

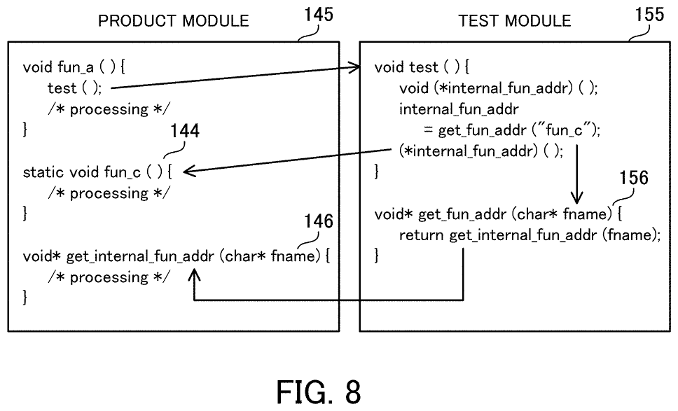

FIG. 8 illustrates a fourth example of a product module and a test module.

A product module 145 includes a function fun_a, a function fun_c (function 144), and a function get_internal_fun_addr (function 146). The function 146 is a utility function that receives a function name fname as a parameter and that transfers the address of the function determined by the parameter as a response. The function 146 is a global function that even an external module is able to invoke by using a function name. The function 146 may be referred to as an address resolution function.

The function 146 and the function 144 belong to the same module. Thus, when the function 146 receives the function name of the function 144 as a parameter, the function 146 is able to search for the address of the function 144 by using the function name, based on a normal address resolution mechanism of the program. The address transferred by the function 146 as a response is a memory address that indicates the top of a memory area in which the function 144 has been loaded. The function fun_a invokes the function test of a test module 155.

The test module 155 includes a function test and a function get_fun_addr (function 156). The function 156 is a utility function that receives a function name fname as a parameter and that transfers the address of the function determined by the parameter as a response. The function 156 may be referred to as an address resolution function. The function 156 mediates the resolution of the address of the function between the function test and the function 146 of the product module 145. The function 156 invokes the function 146 by using the received function name as a parameter, receives a pointer that indicates the address of the function from the function 146, and transfers the received pointer to the function test.

The function test invokes the function 156 by specifying a function name of a non-global function to be used among the functions of the product module 145. The function test invokes the function indicated by the pointer received from the function 156 by using the address instead of the function name.

As described above, the function fun_a of the product module 145 invokes the function test of the test module 155. The function test queries the function 156 of the test module 155 about the address of the function 144. The function 156 queries the function 146 of the product module 145 about the address of the function 144. The function 146 notifies the function 156 of the address, and the function 156 notifies the function test of the address. The function test invokes the function 144.

In the above resolution of the address of the local variable, the test module 152 includes the stack offset table 175. In this respect, the product module 142 may be configured to include an address resolution function of referring to the stack offset table 175, and the test module 152 may be configured to query the product module 142 about the address of the local variable.

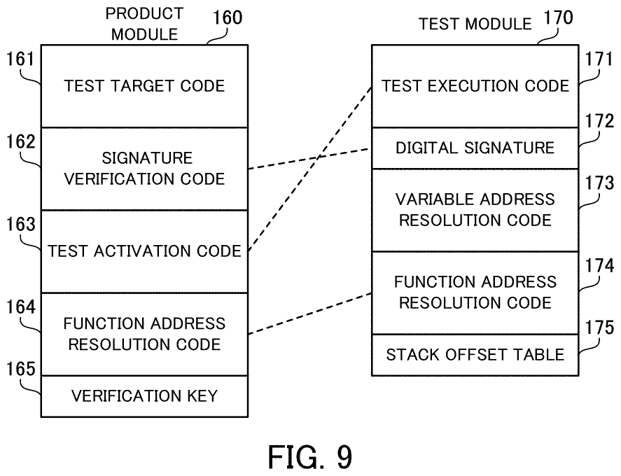

FIG. 9 illustrates a structural example of a product module and a test module.

This product module 160 includes a test target code 161, a signature verification code 162, a test start code 163, a function address resolution code 164, and a verification key 165. The test module 170 includes a test execution code 171, a digital signature 172, a variable address resolution code 173, a function address resolution code 174, and a stack offset table 175. The stack offset table 175 may be separated from the test module 170 or may be embedded into the variable address resolution code 173.

The test target code 161 is the program of the product module 160 to be tested. The test target code 161 may include a function having a local variable. The test target code 161 may include a non-global function such as the function 144.

The signature verification code 162 is a program that verifies the digital signature 172 included in the test module 170 by using the verification key 165 included in the product module 160. The verification of the digital signature 172 reduces the security risk that the product module 160 could invoke an unauthorized test module created by an attacker. For example, the signature verification code 162 calculates a digest of the portions other than the digital signature 172 of the test module 170 by using a hash function, decrypts the digital signature 172 with the verification key 165, and determines whether the digest and the decryption result match. If the digest and the decryption result match, the signature verification code 162 determines that the verification has succeeded. If not, the signature verification code 162 determines that the verification has failed.

The test start code 163 is a program that invokes the test execution code 171 included in the test module 170. When a software product is started based on a command including a test number option, the test start code 163 invokes the test execution code 171 by transferring the test number as a parameter. However, if the test module 170 is not found or if the verification performed by the signature verification code 162 fails, the test start code 163 skips invoking the test execution code 171.

The function address resolution code 164 is a program that transfers the address of a non-global function in response to a request from the test module 170. The function address resolution code 164 corresponds to the above function 146. The function address resolution code 164 receives a function name as a parameter, searches the test target code 161 for a non-global function having the specified function name, and transfers the address of the non-global function on a memory as a response.

The verification key 165 is an encryption key used for the verification of the digital signature 172. Normally, the verification key 165 is a public key that forms a pair with a private key used for the digital signature 172. The pair of public key and private key is held by the developer of the product module 160.

The test execution code 171 is a program that forcibly changes the internal state of the product module 160 to an abnormal state corresponding to a specified test number. The test execution code 171 corresponds to the above function test. The test execution code 171 rewrites the value of a variable defined by the test target code 161 to an abnormal value on a memory. In this operation, the test execution code 171 may invoke the variable address resolution code 173 to acquire the address of the local variable. In addition, the test execution code 171 may invoke the function address resolution code 174 to acquire the address of a non-global function.

The digital signature 172 is encrypted text that proves the validity of the developer of the test module 170. For example, the digital signature 172 is generated by encrypting a digest of the other portions of the test module 170 with a private key held by the developer of the product module 160. The verification of the digital signature 172 succeeds only when the digital signature 172 is decrypted by the verification key that forms a pair with the private key.

The variable address resolution code 173 is a program that transfers the address of the local variable on a memory in response to a request from the test execution code 171. The variable address resolution code 173 corresponds to the above function 153. The variable address resolution code 173 receives a function name and a variable name as parameters and searches the stack offset table 175 for an offset corresponding to the function name and the variable name. The variable address resolution code 173 determines a frame pointer corresponding to the function name in the stack area 176 and calculates the address of the local variable by adding the offset to the frame pointer.

The function address resolution code 174 is a program that transfers the address of a non-global function on a memory in response to a request from the test execution code 171. The function address resolution code 174 corresponds to the above function 156. The function address resolution code 174 receives a function name as a parameter, invokes the function address resolution code 164, and transfers the address acquired from the function address resolution code 164 to the test execution code 171.

Next, a function and processing procedure of the information processing apparatus 100 will be described.

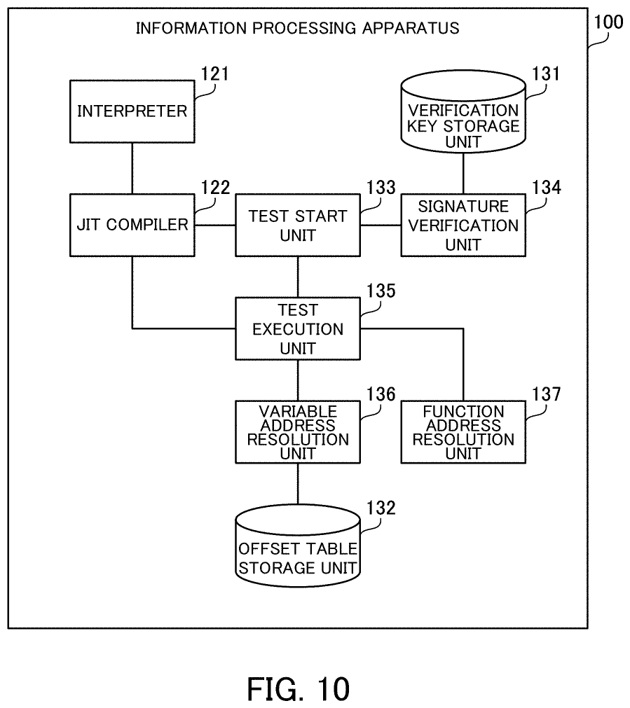

FIG. 10 is a block diagram illustrating a functional example of the information processing apparatus.

The information processing apparatus 100 includes an interpreter 121, a JIT compiler 122, a verification key storage unit 131, an offset table storage unit 132, a test start unit 133, a signature verification unit 134, a test execution unit 135, a variable address resolution unit 136, and a function address resolution unit 137. The verification key storage unit 131 and the offset table storage unit 132 are implemented by using the RAM 102 or the HDD 103. The verification key storage unit 131 holds the verification key 165. The offset table storage unit 132 holds the stack offset table 175.

The test start unit 133 operates in accordance with the test start code 163. The signature verification unit 134 operates in accordance with the signature verification code 162. The test execution unit 135 operates in accordance with the test execution code 171. The variable address resolution unit 136 operates in accordance with the variable address resolution code 173. The function address resolution unit 137 operates in accordance with the function address resolution code 164 and the function address resolution code 174.

When the JIT compiler 122 starts a compilation thread, the test start unit 133 determines whether a test number option is included in the command and whether the test module 170 exists in a certain directory. When these conditions are met, the test start unit 133 requests the signature verification unit 134 to perform verification processing on the digital signature 172. If the verification of the digital signature 172 succeeds, the test start unit 133 invokes the test execution unit 135. If the test number option is not included in the command, if the test module 170 does not exist, or if the verification of the digital signature 172 fails, the test start unit 133 does not invoke the test execution unit 135. In this case, the compilation thread is performed in a normal manner.

In response to a request from the test start unit 133, the signature verification unit 134 extracts the digital signature 172 from the test module 170 and performs verification processing on the digital signature 172 by using the verification key 165 stored in the verification key storage unit 131. The signature verification unit 134 notifies the test start unit 133 of the success or failure of the verification processing performed on the digital signature 172.

By rewriting the value of the variable defined in the JIT compiler 122 to an abnormal value corresponding to the specified test number, the test execution unit 135 forcibly creates a certain abnormal state. Next, the test execution unit 135 causes the JIT compiler 122 to perform the compilation thread in the abnormal state. As a result, the JIT compiler 122 performs recovery processing to manage the created abnormal state. In the process of creating the abnormal state, the test execution unit 135 may query the variable address resolution unit 136 about the address of a local variable or may query the function address resolution unit 137 about the address of a non-global function.

The variable address resolution unit 136 receives a function name and a variable name from the test execution unit 135. Next, the variable address resolution unit 136 searches the stack offset table 175 stored in the offset table storage unit 132 for an offset corresponding to the pair of function name and variable name. The variable address resolution unit 136 calculates the address of the local variable by adding the offset to the frame pointer corresponding to the function name.

The function address resolution unit 137 receives the function name from the test execution unit 135. Next, the function address resolution unit 137 resolves the address of the non-global function corresponding to the specified function name through communication between the product module and the test module.

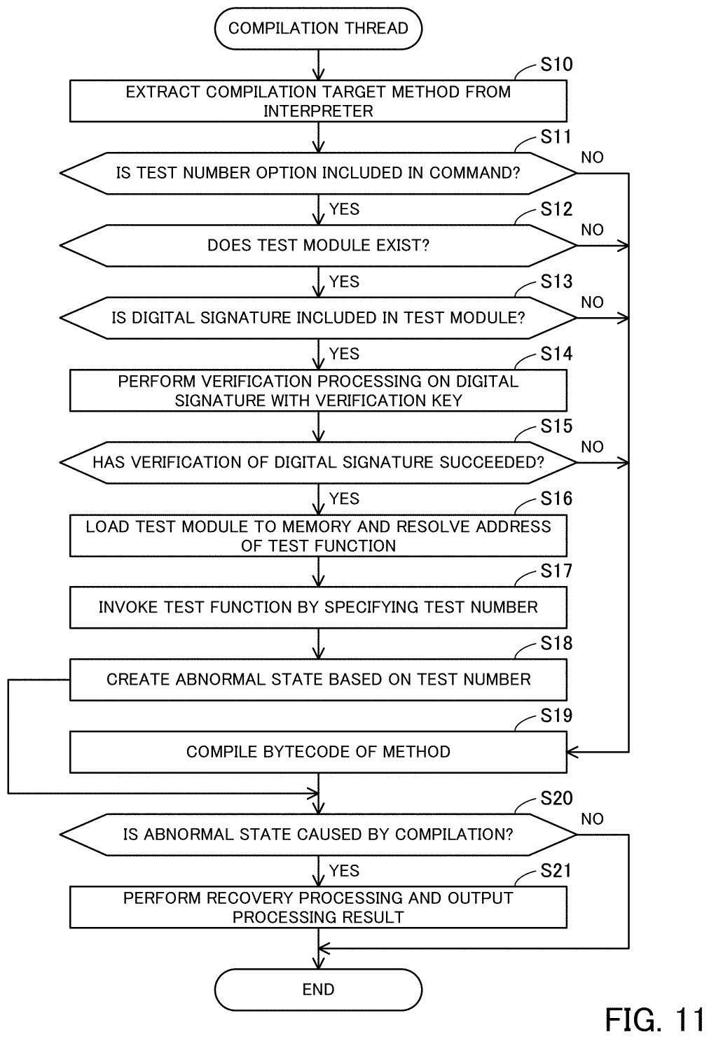

FIG. 11 is a flowchart illustrating a procedure example of a compilation thread.

(S10) The JIT compiler 122 receives a compilation request from the interpreter 121. The JIT compiler 122 determines a class name of a compilation target method and its method name and extracts a bytecode of the method.

(S11) The test start unit 133 determines whether a test number option is included in a command for starting the program execution environment 120. If a test number option is included in the command, the processing proceeds to step S12. If a test number option is not included in the command, the processing proceeds to step S19.

(S12) The test start unit 133 searches the file system for a test module, to determine whether a test module exists. If a test module exists, the processing proceeds to step S13. If a test module does not exist, the processing proceeds to step S19.

(S13) The signature verification unit 134 searches the test module for a digital signature, to determine whether a digital signature is included in the test module. If a digital signature is included in the test module, the processing proceeds to step S14. If a digital signature is not included in the test module, the processing proceeds to step S19.

(S14) The signature verification unit 134 extracts the digital signature from the test module. The signature verification unit 134 reads a verification key and performs verification processing on the digital signature with the verification key.

(S15) The signature verification unit 134 determines whether the verification of the digital signature has succeeded. If the verification of the digital signature has succeeded, the processing proceeds to step S16. If the verification of the digital signature has failed, the processing proceeds to step S19.

(S16) The test start unit 133 loads the test module to a memory and resolves the address of a test function included in the test module. Regarding the resolution of the address of the test function, a correspondence relationship between the function name of the test function and the corresponding address on the memory is held.

(S17) The test start unit 133 invokes the test function of the test module by transferring the test number specified by the test number option in the command as a parameter.

(S18) The test execution unit 135 performs processing in accordance with the test number received from the test start unit 133. In this operation, the test execution unit 135 creates a certain abnormal state in the JIT compiler 122 by rewriting the value of the variable defined by the JIT compiler 122 to a certain abnormal value. Since recovery processing is started due to the occurrence of an abnormal state, the test execution unit 135 may skip the compilation of the bytecode by the JIT compiler 122. Examples of the abnormal state include memory access violation, internal contradiction detection, and a no-response state. Next, the processing proceeds to step S20.

(S19) The JIT compiler 122 compiles the bytecode of the method specified by the interpreter 121 into a native code.

(S20) The JIT compiler 122 determines whether an abnormal state has occurred during the compilation of the bytecode. An abnormal state could practically occur during the compilation processing in step S19 or a simulated abnormal state may be created as in step S18. If an abnormal state occurs, the processing proceeds to step S21. If an abnormal state does not occur, the processing of the compilation thread in response to the request from the interpreter 121 ends. The compilation thread itself remains active until the user program 123 stops.

(S21) The JIT compiler 122 stops the compilation of the bytecode and starts recovery processing. The JIT compiler 122 performs recovery processing for recovering the memory state such that other functions of the program execution environment 120 are not affected. The JIT compiler 122 outputs the result of the above series of processing.

For example, the JIT compiler 122 outputs an error message if the test module is not invoked while a test number option is included in the command. If the JIT compiler 122 performs the recovery processing, the JIT compiler 122 outputs information about the abnormal state that has triggered the recovery processing and the result of the recovery processing. The JIT compiler 122 may record the processing result in a log file or display the processing result on the display device 111. The JIT compiler 122 may transmit the processing result to a different information processing apparatus.

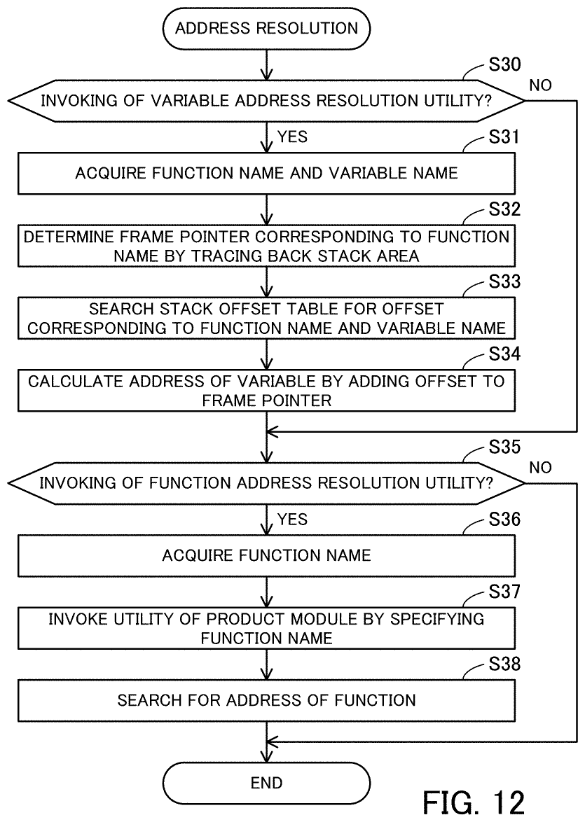

FIG. 12 is a flowchart illustrating a procedure example of address resolution.

(S30) The test execution unit 135 determines whether the test function defines invoking a variable address resolution utility. If invoking a variable address resolution utility is defined, the processing proceeds to step S31. If invoking a variable address resolution utility is not defined, the processing proceeds to step S35.

(S31) The variable address resolution unit 136 acquires from the test execution unit 135 the function name and the variable name of a local variable targeted by the test function for reference.

(S32) The variable address resolution unit 136 determines a frame pointer corresponding to the specified function name by tracing back the stack area from the section of the test function.

(S33) The variable address resolution unit 136 searches the stack offset table 175 for an offset corresponding to the pair of function name and variable name specified.

(S34) The variable address resolution unit 136 calculates the address of the local variable by adding the offset found in step S33 to the frame pointer determined in step S32. The variable address resolution unit 136 transfers the calculated address to the test function.

(S35) The test execution unit 135 determines whether the test function defines invoking a function address resolution utility. If invoking a function address resolution utility is defined, the processing proceeds to step S36. If invoking a function address resolution utility is not defined, the present address resolution ends.

(S36) The function address resolution unit 137 acquires the function name of a non-global function that the test function needs to invoke from the test execution unit 135.

(S37) The function address resolution unit 137 invokes the function address resolution utility, which is a global function in the product module by specifying the function name.

(S38) The function address resolution unit 137 searches, as processing in the product module, for the address of the non-global function having the specified function name. The function address resolution unit 137 transfers the address of the function to the test module and to the test function.

As described above, the information processing apparatus 100 according to the second embodiment performs a test on the recovery processing that the JIT compiler 122 included in the program execution environment 120 performs. In this way, defects of the recovery processing are found, and the quality of the JIT compiler 122 is improved through debugging. In addition, by using a test module, the information processing apparatus 100 rewrites the value of a variable included in the JIT compiler 122 to an abnormal value and creates a simulated abnormal state. In this way, the information processing apparatus 100 is able to create an abnormal state, which is difficult to recreate only by a normal input operation, and to efficiently test the recovery processing on various abnormal states.

In addition, the test module that sets an abnormal state is separated from the program execution environment 120 and is implemented as a dynamic link library invoked by the JIT compiler 122 when a test number option is specified. In this way, since the developer does not need to embed a test code into the program execution environment 120, the burden of managing the quality of the program execution environment 120 is reduced. In addition, even when changing the test content, the developer does not need rebuild the program execution environment 120. Thus, the test work is performed more efficiently.

In addition, unlike a case where the operation of the JIT compiler 122 is verified by using a debugger, the developer does not need to perform low-level operations such as execution of the steps of the program instructions and memory rewriting, and therefore, the developer's learning cost for learning test technique is reduced. In addition, a single test module is able to create various abnormal states by causing the JIT compiler 122 to notify the test module of test numbers. In addition, since a digital signature is added to the test module, the risk that the JIT compiler 122 invokes an unauthorized external module is reduced. As a result, the security is improved.

In addition, the test module includes a stack offset table prepared in advance based on the data structure of a stack area determined by a compiler and a utility function that calculates the address of a local variable from the corresponding offset. By using this utility function, the test module, which is an external module, is able to access the value of a local variable of a function included in the JIT compiler 122. In addition, using this utility function reduces the burden of the developer who implements the test function.

In addition, the JIT compiler 122 includes a global function that searches for the address of a function from a function name and that transfers the address as a response. The test module includes a utility function that queries this global function about the address of the function. By using this utility function, the test module, which is an external module, is able to invoke a non-global function included in the JIT compiler 122. In addition, using this utility function reduces the burden of the developer who implements a test function.

In one aspect, a software test is facilitated.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
invoking, based on a test specification information that indicates execution of software in a test mode, a test program configured separately from the software;
determining an address that indicates a variable for use by a function included in the software, by using the test program being invoked; and
rewriting a value of the variable indicated by the address.

2. The non-transitory computer-readable recording medium according to claim 1, wherein:
the variable is a local variable of the function, and the test program holds offset information in which a variable name and an offset from a reference location in a stack area are associated with each other; and
the test program defines processing for acquiring an offset corresponding to the variable from the offset information and calculating the address by using the offset being acquired.

3. The non-transitory computer-readable recording medium according to claim 1, wherein the value of the variable is rewritten to an abnormal value that indicates an abnormal internal state of the software.

4. The non-transitory computer-readable recording medium according to claim 1, wherein:
the test specification information includes a test number that identifies a test case; and
the value of the variable is rewritten to a different value depending on the test number.

5. The non-transitory computer-readable recording medium according to claim 1, wherein:
the software further includes a local function, reference thereto by using a function name being restricted, and an address resolution function that outputs another address that indicates a location of the local function; and
the process further includes acquiring the another address from the address resolution function and invoking the local function based on the another address by using the test program being invoked.

6. The non-transitory computer-readable recording medium according to claim 1, wherein:
the test program includes a digital signature; and
the process further includes verifying the digital signature by using a certain encryption key and denying the invoking of the test program when the verifying fails.

7. A test processing method comprising:
invoking, by a processor, based on a test specification information that indicates execution of software in a test mode, a test program configured separately from the software;
determining, by the processor, an address that indicates a variable for use by a function included in the software, by using the test program being invoked; and
rewriting, by the processor, a value of the variable indicated by the address.

8. An information processing apparatus comprising:
a memory configured to hold software and a test program configured separately from the software; and
a processor configured to execute a process including:
invoking the test program, based on a test specification information that indicates execution of the software in a test mode;
determining an address that indicates a variable for use by a function included in the software, by using the test program being invoked; and
rewriting a value of the variable indicated by the address.
